(19) United States
(12) Patent Application Publication
(10) Pub. No.: US 2020/0086385 A1
(43) Pub. Date: Mar. 19, 2020

(54) FLASH-SINTERED COMPOSITE MATERIALS AND METHODS OF FORMING SAME

(71) Applicant: The Regents of the University of Colorado, a body corporate, Denver, CO (US)

(72) Inventors: Rishi Raj, Boulder (CO); Zayna Pieper, Calhan, CO (US)

(21) Appl. No.: 16/136,054

(22) Filed: Sep. 19, 2018

(51) Int. Cl. B22F 3/105; H01M 4/04; H01M 4/1391; H01M 4/131

(52) U.S. Cl. CPC B22F 3/105; H01M 4/0471; H01M 4/1391; H01M 4/131; H01M 10/0525; B22F 2302/25; B22F 2301/255; B22F 2301/052; B22F 2301/15

(57) ABSTRACT

Methods of forming metal-ceramic composite materials using flash sintering are disclosed. Exemplary methods include providing mixture comprising one or more materials (e.g., one or more metal oxide powders) and a metal and flash sintering the mixture to form the metal-ceramic compound.

### STATEMENT REGARDING FEDERALLY-SPONSORED RESEARCH OR DEVELOPMENT

This invention was made with government support under grant number DE-AR0000777 awarded by ARPA-E. The government has certain rights in the invention.

### CROSS-REFERENCE TO RELATED APPLICATIONS

This application is filed concurrently with U.S. application Ser. No. 16/136,043, entitled “METHOD OF FORMING A SINTERED COMPOUND AND COMPOUND FORMED USING THE METHOD,” and filed Sep. 19, 2018, and U.S. application Ser. No. 16/136,063, entitled “STRUCTURE INCLUDING A THIN-FILM LAYER AND FLASH-SINTERING METHOD OF FORMING SAME,” and filed Sep. 19, 2018, the contents of which are hereby incorporated herein by reference.

### FIELD OF THE DISCLOSURE

The present disclosure generally relates to materials formed using flash sintering techniques and the methods of forming the materials. More particularly, the disclosure relates to methods of flash sintering and to materials formed using flash sintering.

### BACKGROUND OF THE DISCLOSURE

Electrochemical cells generally include an anode, a cathode, and an electrolyte, typically a liquid electrolyte. During discharge of an electrochemical cell, an oxidation-reduction reaction occurs, causing electrons to flow, through an external circuit, from the anode to the cathode, and cations are attracted from the anode to the cathode.

Batteries that include one or more electrochemical cells can be used to power a variety of devices, such as mobile phones, portable computers, other portable devices, electric or hybrid cars, as well as many other appliances. For many applications, it is desirous to use electrochemical cells with relatively low weight and relatively high energy density (energy that can be derived from a cell per unit volume of the cell) and/or relatively high specific energy density (energy that can be derived per unit weight of the cell or per unit weight of the active electrode material), so that desired energy can be supplied to a device using the cell, while minimizing the mass and/or volume of the cell.

Because of their high voltage and energy density, batteries that include a lithium metal anode have become a subject of much interest. However, such batteries, particularly when such batteries include a liquid electrolyte, can pose serious safety concerns.

Recently, solid state batteries have been proposed as an option to safely enable the use of lithium anodes in electrochemical cells. The use of solid-state electrolytes can have a further advantage of increasing the energy, power density, and lifetime of lithium ion batteries. In the case of solid-state batteries, the electrolyte is not consumed in a lithium ion battery, providing for the potential of extended battery life coupled with a high energy and power density. Such batteries have been used widely in high tech fields and are emerging in the electric car industry.

Cathodes for solid-state lithium ion batteries desirably conduct both (e.g., mixed) ionic and electronic currents. Many solid-state lithium ion batteries include lithium cobalt oxide—e.g., LiCoO2 or LCO, as the cathode. Such materials can be formed by conventional flash sintering, which can be relatively expensive and time consuming. Furthermore, it may be difficult to obtain desired properties of such materials using typical manufacturing techniques. Accordingly, improved methods of forming composite compounds, such as composite compound suitable for use as a solid-state electrochemical component (e.g., a cathode), are desired.

### SUMMARY OF THE DISCLOSURE

This summary is provided to introduce a selection of concepts in a simplified form. These concepts are described in further detail in the detailed description of example embodiments of the disclosure below. This summary is not intended to necessarily identify key features or essential features of the claimed subject matter, nor is it intended to be used to limit the scope of the claimed subject matter.

Various embodiments of the present disclosure relate to methods of forming metal-ceramic composite materials. The composite materials can be used in a variety of applications, such as electrochemical cell components. By way of particular examples, the composite materials are suitable for use as cathodes in electrochemical cells and/or anodes in fuel cells.

In accordance with at least one exemplary embodiment of the disclosure, a method of forming a metal-ceramic composite electrode includes the steps of providing mixture comprising one or more materials and a metal and flash sintering the mixture to form the metal-ceramic compound. In accordance with various aspects of these embodiments, the metal (e.g., silver and or aluminum) exhibits solubility for lithium. In accordance with further aspects, one or more of the materials comprise one or more of lithium and cobalt—e.g., lithium oxide and/or cobalt oxide. An amount of metal in the mixture ranges from about 2 volume % to about 20 volume %, about 3 volume % to about 18 volume % or about 5 volume % to about 15 volume %. A temperature during the step of flash sintering can be ramped at a substantially constant (e.g., plus or minus about ten percent) to a flash temperature. The metal-ceramic compound can be used to form an electrode of an electrochemical cell or a fuel cell.

In accordance with at least one embodiments of the disclosure, a sintered metal-ceramic compound is formed according to a method described herein. The sintered metal-ceramic compound can comprise, for examples, about 5 vol % to about 50 vol % of a metal, such as aluminum or silver, and about 95 vol % to about 50 vol % ceramic material, such as lithium cobalt oxide. The sintered metal-ceramic compound can form part of an electrochemical cell, a fuel cell, and/or a battery.

In accordance with yet an additional embodiment of the disclosure, a method of forming an electrode includes the steps of: providing mixture comprising one or more materials and a metal, and flash sintering the mixture to form a metal-ceramic compound. The one more materials can be or include one or more of lithium oxide, cobalt oxide, and lithium cobalt oxide. The metal can be or include one or more of silver and aluminum.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates plots of electric field, current density and power density during flash sintering of LCO without a metal and with 10 vol % metal (silver) added in accordance with at least one embodiment of the disclosure. The onset of the flash is signaled by an abrupt rise in the current density after the application of the field (e.g., applied as a step function).

FIG. 2 illustrates optical micrographs of surfaces of two silver composites in accordance with at least one embodiment of the disclosure, showing uniform dispersion of metal within the ceramic.

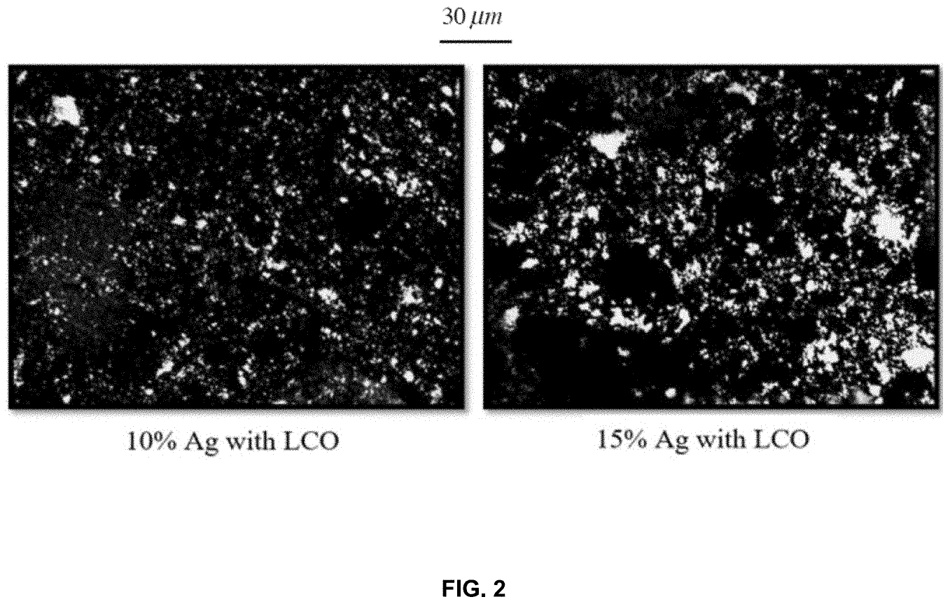

FIG. 3 illustrates DC resistance measured from the slope of the I-V curve in accordance with at least one embodiment of the disclosure.

FIG. 4 illustrates lumped circuit models for the two types of cells, one with copper and the other with lithium electrodes in accordance with at least one embodiment of the disclosure.

It will be appreciated that elements in the figures are illustrated for simplicity and clarity and have not necessarily been drawn to scale. For example, the dimensions of some of the elements in the figures may be exaggerated relative to other elements to help to improve the understanding of illustrated embodiments of the present disclosure.

### DETAILED DESCRIPTION OF EXEMPLARY EMBODIMENTS OF THE DISCLOSURE

The description of exemplary embodiments provided below is merely exemplary and is intended for purposes of illustration only; the following description is not intended to limit the scope of the disclosure or the claims. Moreover, recitation of multiple embodiments having stated features is not intended to exclude other embodiments having additional features or other embodiments incorporating different combinations of the stated features.

The present disclosure generally relates to methods of forming sintered metal-ceramic composite compounds and electrodes including the compounds. Exemplary methods include providing mixture comprising one or more materials and a metal and flash sintering the mixture to form a metal-ceramic compound. The one or more materials can include lithium. The metal can include a metal, such as silver or aluminum that exhibit solubility for lithium.

In accordance with various embodiments of the disclosure, flash sintering is used to form the metal-ceramic material, such as metal-ceramic material suitable as electrode (e.g., electrochemical cell or fuel cell electrode) material. Flash sintering, as described herein, is an enabling process for sintering various compounds, including (i) Li-containing complex oxides where Li is highly mobile, and therefore fugitive, and (ii) where there is a desire to make composites of metals and ceramics. The first attribute comes from the very short sintering time (a few seconds) and low sintering temperature (e.g., about 300° C. to about 1200° C., less than 1000° C., 850° C., 650° C., or 600° C.), and the second from the ability of flash to induce strong bonding at the metal-ceramic interfaces. By way of examples, flash sintering of composites of lithium oxides and three metals; aluminum, nickel and silver, with the metal content ranging from 5 vol % to 15 vol %, can be formed. ASR values for electronic and ionic transport can range from about 5 to about 9 Ωcm−2 and the electronic resistance can be in the 2-7 Ωcm2 range. Aluminum and nickel composites had ASR values which were one to two orders of magnitude higher. It is surprising that silver and aluminum enhance both electronic as well as ionic transport, which can be attributed to the significant diffusivity of Li ions along the metal-ceramic interfaces induced by flash sintering. Flash sintering is a fast process where sintering is completed in mere seconds (e.g., less than 10, or about 0.5 to about 10, about 2 to about 8, or about 1 to about 3 seconds) in ambient air.

The selection of materials for cathodes in lithium ion electrochemical cells and batteries can be based upon the electrochemical activity of the material with lithium, which should be significantly lower than the lithium activity in the anode, in order to maximize an open circuit voltage of the electrochemical cell including such cathode material. Furthermore, the cathode should (i) transport lithium ions from the electrolyte to within the active cathode material, and (ii) transport electrons from the electrolyte-cathode material interface to a current collector. That is, cathode materials are desirably mixed ionic-electronic conductors. The current engineering solution to electronic conductivity is to mix carbon black with the oxide powder. In this case, ionic conductivity is achieved by infiltrating the porous structure of this powder mixture with the liquid electrolyte.

Cathodes for solid state batteries can be formed by conventional sintering. In such cases, powder of the active materials is sintered into free-standing electrodes that can be assembled into cells. Sintering of ceramics by conventional methods generally requires several hours at high temperatures. For example, conventional sintering of lithium cobalt oxide (LCO) requires over six hours at 700° C. to 1000° C. Lithium ions are highly mobile in the electrolyte at room temperature; as the high temperatures and long periods of time required for conventional sintering lithium can escape into the atmosphere.

Three phase composites constituted from an electrolyte, a metal, and the cathode material of a conventional cell, could be used to form a cathode electrode for solid-state lithium ion batteries. However, conventional sintering of such composites is likely to be even more difficult than sintering of LCO and LLZO, as described just above. Each phase of the material would likely sinter at different rates, which can give rise to issues of differential or “constrained sintering,” where the slowest sintering phase controls the overall sintering rate, and where the rapidly sintering component can delaminate and produce microcracks in the sintering body.

However, flash sintering, as described herein, can be effective in densifying powders of LLZO and other materials. In flash sintering, a modest electrical field is applied to free-standing specimens placed within, e.g., a conventional furnace or reaction chamber. Ceramics have been shown to sinter in just a few seconds at temperatures well below 1000° C. For example, yttria stabilized zirconia, which normally requires several hours at 1400° C. in conventional sintering, can be fully flash sintered in less than 5 seconds below 850° C. Many ceramics, including semiconductors, ionic conductors, electronic conductors and insulators can be successfully sintered by flash sintering.

Flash sintering can also be used to densify two phase composites and multilayer structures. Therefore, three phase cathode electrodes can also be fabricated by the flash sintering methods described herein.

Generally, flash sintering can be performed in a variety of ways, including applying a voltage to a sample in, e.g., an isothermal furnace, and switching to current control upon the incidence of flash; applying a voltage and heating the furnace at increasing temperature (e.g., increasing temperature at or approximate (e.g., plus or minus about ten percent) at a constant rate) until the onset of the flash; and applying (e.g., proximately isothermal) furnace temperature and increasing the current—e.g., increasing current at or approximately at a constant rate from the very start, without using voltage control. In the latter case, current rates can be varied from, for example, about 50 mA min−1 to 5000 mA min−1, or about 100 mA mm−2. When ramping temperature, the temperature within a reaction chamber can ramped up at a rate between about 1° C./minute to about 100° C./minute (e.g., at or near a constant rate of increasing temperature) and/or to a temperature of about 300° C. to about 1200° C. The following comparisons of current rate to the voltage-to-current experiments are noted (i) in both instances the onset of the flash is signaled by an unusual rise in conductivity; however if the power supply remains in the current control mode, the increase in conductivity is manifested by a drop in the voltage generated across the specimen, (ii) the black body radiation model is modified to include the energy absorbed in specific heat, in order to determine the time dependent change in temperature as the current is increased—this correction is particularly significant at the very high current rates, (iii) sintering occurs continuously, reaching full density, in most or all instances, when the current density reaches ˜100 mA mm−2, and (iv) it is suggested that the current rate experiments yield fine-grained microstructure across the entire gage section of the dog-bone specimen, presumably because the highly transient conditions of voltage-to-current flash experiments are sidestepped. Exemplary apparatus and techniques for flash sintering other materials are disclosed in U.S. Pat. No. 8,940,220, issued on Jan. 27, 2015, in the name of Raj et al. and U.S. Pat. No. 9,334,194, issued on May 10, 2016, in the name of Raj et al., the contents of both of which are hereby incorporated herein by reference to the extent such contents do not conflict with the present disclosure.

### Specific Examples

The examples below illustrate methods of forming composite ceramic-metal materials. The examples below relate to composites that include LCO, an active cathode material and a metal (e.g., aluminum, silver and/or nickel). Ceramic precursor materials (e.g., one or more metal oxide powders) and metal compounds can be co-sintered by the flash sintering method. Suitable metal oxides for forming the ceramic material are disclosed in the '043 application. Flash sintering can impart strength to the metal-ceramic interfaces in these composites, so that the composite materials can be handled as free-standing electrodes. Composite materials as described herein have both electronic and ionic conductivities, thereby demonstrating the suitable use for the fabrication of solid state cathodes for lithium ion batteries.

Materials and Sample Preparation

Starting powders for the fabrication of composites of LiCO2 and the three metals, aluminum, silver and nickel were obtained as follows—the particle size from the manufacturer is given within the brackets: LCO powder (C965D38 ALDRICH, 0.5 μm), silver powder (327085 ALDRICH, 2-3.5 μm), nickel powder (43214 ALFA AESAR, 44 μm), aluminum powder (10576 Alfa Aesar, 20 μm). A liquid binder (DURAMAX B-1000) was used to hold the green powder compact for handling. The mixture was dried at 100° C. for 1 hour, crushed, and mixed into a powder. This powder was then pressed using 230 N into a dog-bone mold with a gage length of 15 mm, and a width of 3.35 mm, and thickness which ranged from 0.08 to 0.12 cm. The total surface area of the dog-bone, including the ears, which was determined by the dimensions of the mold, was about 1.32 cm². The total weight of the dog-bones ranged from about 0.31 to 0.45 g.

Samples were prepared with 5 vol %, 10 vol % and 15 vol % (aluminum containing samples only 5 vol % and 10 vol %) of each of the metal powders. The powders were pressed in the mold and then heated according to the following schedule to burn out the binder. The dog-bone specimens were heated at a rate of 2° C. min−1 up to 600° C. The specimens were held at 600° C. for about three hours and then the furnace was cooled down to about 450° C., and the flash sintering experiment was initiated as described below.

Flash Sintering

Flash sintering methods were carried on free-standing samples placed inside a conventional furnace, usually in ambient air atmosphere. An exemplary furnace is illustrated in the '043 application. There are generally three variables in the process; the furnace temperature, the electric field and the current passing through the specimen. Of course, either the voltage or the current can be controlled at any one time, generally not both. The flash methods were carried out in two ways: by heating the furnace at a constant heating rate (e.g., within about 10 percent of a constant rate), or by holding the furnace (reaction chamber) at an isothermal temperature. In either case, the flash initiates at a specific combination of electric field and temperature. The flash initiation is signaled by a sharp rise in conductivity and the current flowing through the specimen rises quickly. Flash initiation is also accompanied by electroluminescence in the visible and the near infrared. At this point, the power supply is switched (e.g., automatically) to current control mode, which limits the current to a preset value (e.g., about 100 to about 300, or about 250 mA mm). Sintering occurs in just a few seconds (e.g., less than 10 or less than 5 seconds) as the power supply is switched from voltage to current control. The onset of the flash can be determined by the field and the furnace temperature, and the extent of sintering can depend on the current limit.

In constant temperature rate increase methods, the electric field is applied at the start of the heating cycle, and flash occurs almost instantaneously upon reaching a certain temperature. In the isothermal methods, the field is increased—e.g., applied as a step function once the specimen comes up to the furnace temperature; there is often an incubation time before the onset of the flash sintering. The duration of the incubation time can depend on the field strength and the furnace temperature.

Experiments were carried out in different ways, and eventually the parameters used for all experiments are given in Table I.

TABLE I
The parameters for the flash sintering experiments.

| Experiment Type | Isothermal furnace temperature |
|---|---|
| Furnace Temperature | 450° C. |
| Electric Field | 65 V cm⁻¹ |
| Current Density Limit | 250 mA mm⁻² |
| Environment | Ambient Air |

The experiments were carried out by suspending the dog-bone shaped samples with platinum wires, which were looped into two small holes in the ears of the samples.

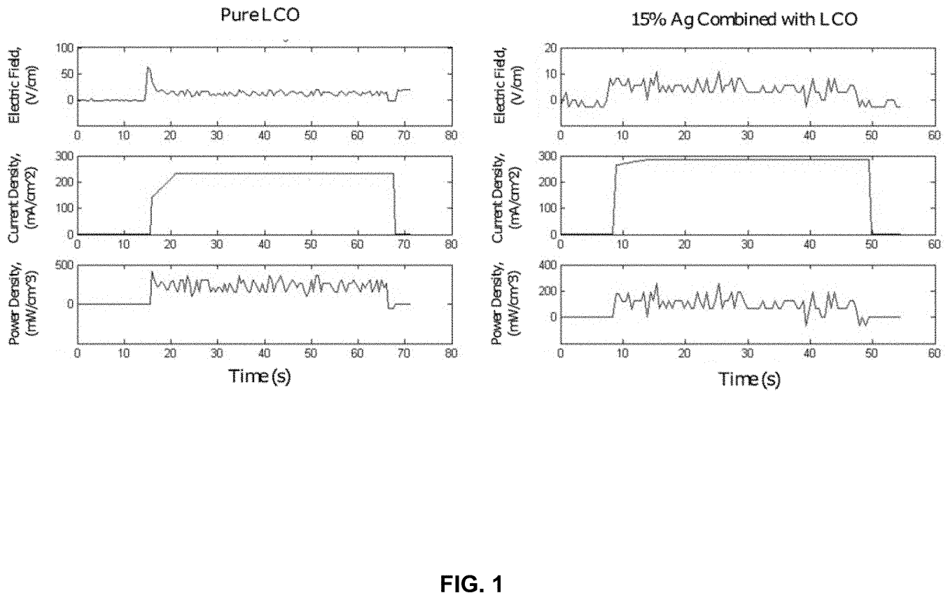

Plots of the electric field, the current density and the power density (equal to the product of the field and the current density) versus time for samples, without metal and with ten volume percent silver, during flash sintering are illustrated in FIG. 1. FIG. 1 illustrates a comparison of the power response of the specimen with and without the addition of the metal. Results for LCO without the metal, left side of FIG. 1, show the onset of the flash nearly instantaneously after the application of the electric field as a step function; the current rises and as the power supply switches to current control, the voltage developed across the specimen reaches a steady value. Since the current is constant, the power expended in the specimen also reaches a constant value, albeit with some fluctuations.

The graphs for 15 vol % Ag composites, right side of FIG. 1, show similar behavior except that the incubation time is so brief that the voltage is not able to rise to the specified value before the power supply switches to current control. The power density and the electric field developed under current control are nearly the same for the un-doped and the metal-containing ceramics. This may suggest that pure LCO becomes electronically conducting at the onset of the flash.

A density of the flashed specimens was determined by measuring the volume and mass of each sample. The relative density values, normalized for the theoretical density of the specimens of various compositions, are given in Table II. Contrary to the experience with flash sintering of simple oxides, which can sinter to high densities that range from 80% to 97%, the present experiments did not show significant densification. Density increased marginally above the green density, which was ˜50%.

TABLE II
Density of the samples.

| | | Range of | |
|---|---|---|---|
| Sample | Number of | Relative | Average |
| Composition | Tests | Densities | Density |
| Pure LCO | 3 | 60.5-62.3 | 61.5 |
| 5 vol % Ag | 4 | 56.6-59.6 | 58.3 |
| 10 vol % Ag | 4 | 50.7-58.3 | 54.6 |
| 15 vol % Ag | 2 | 50.0-58.3 | 54.1 |
| 5 vol % Al | 2 | 55.1-60.4 | 57.8 |
| 10 vol % Al | 2 | 55.7-59.7 | 57.7 |
| 5 vol % Ni | 4 | 57.7-61.1 | 59.7 |
| 10 vol % Ni | 4 | 55.4-72.6 | 61.0 |
| 15 vol % Ni | 3 | 62.07-63.7 | 62.9 |

Evidence suggests that flash conditions improve metal ceramic wetting, which can be expected to reduce the ionic and electronic resistance of these interfaces.

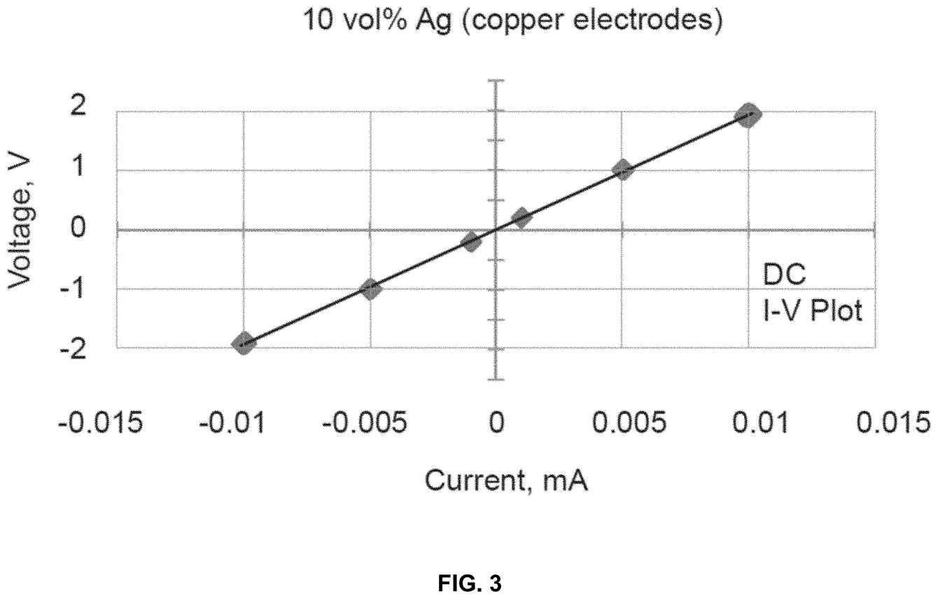

The mechanical strength of the flashed specimen was considerably greater than in the green state. The specimens could be cut and handled with ease for electrochemical measurements, where before sintering the specimens were very fragile. The micrographs shown in FIG. 3 also suggest a good wetting and dispersion of the metal within the ceramic matrix. The silver particles appear as bright specks; their abundance is higher with the higher volume fraction of silver.

Electrochemical Measurements

The electrochemical measurements were used to measure the influence of flash on the ionic and electronic conductivity of the flash-sintered metal-ceramic compounds. The measurements below were carried out with copper electrodes on both sides, which blocked ionic transport and therefore gave a measure of the electronic conductivity. A second set of measurements were made with non-blocking lithium metal electrodes, which gave the sum of the ionic and electronic transport in the electrolyte. In this manner, a magnitude of the ionic and electronic conductivities and from that, the transference number, could be determined.

Interface resistance was not directly addressed in these measurements. The contact resistance was lumped with the bulk resistivity. The electronic resistance of the metal-ceramic interface may be negligible, since the interface offers points of direct contact between the metal electrode and the metal embedded within the composite.

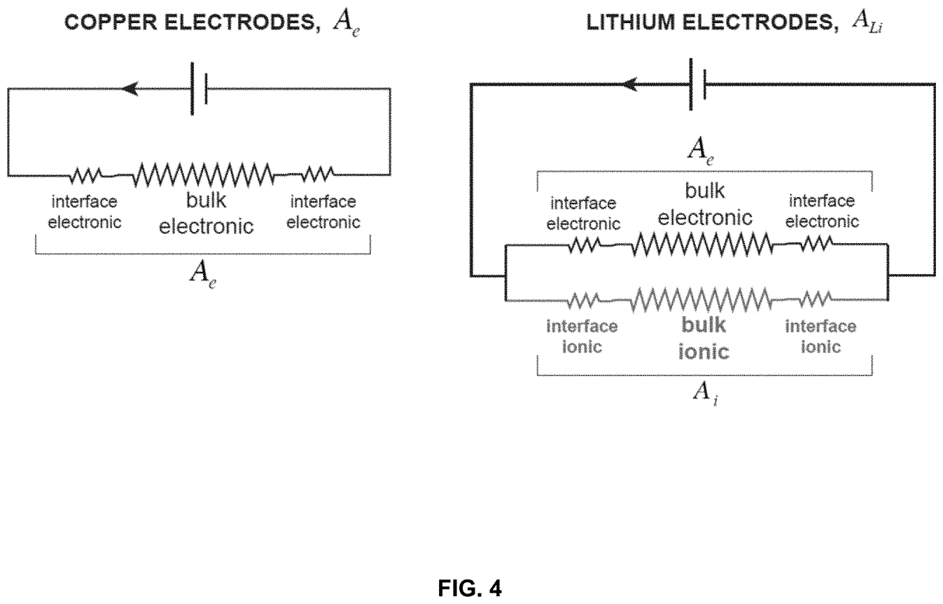

The data were analyzed in terms of area specific resistance or ASR, since these can be presented in a lumped equivalent circuit shown in FIG. 4. The following nomenclature is used for the analysis of the lumped circuit.

Aₑ^{Cu} the electronic ASR of the composite, including the interface ASR. The superscript denotes the copper electrodes.

Aₑ^{Li} the electronic ASR of the composite, including the interface ASR. The superscript denotes the lithium electrodes.

Aᵢ the ionic ASR of the composite, including the interface ASR for charge transfer across the “non blocking” Li-metal electrodes.

The interface resistance for electronic conduction may be negligible and therefore, approximately the same for the copper and lithium electrodes,

Aₑ^{Cu}=Aₑ^{Li}=Aₑ (1)

In further analysis, we assume that Aₑ is equal to the ASR measured with copper electrodes. The lithium electrodes, which are non-blocking, will provide the value for Aₑ and Aᵢ in parallel as shown in the lumped electrical circuit in FIG. 4. Note that Aᵢ is the sum of the bulk ionic resistance as well as the interface resistance arising from the two electrodes. The measured ASR with lithium electrodes is denoted as A_{Li}. It therefore follows that

$$\frac{1}{{A}_{Li}} = \frac{1}{{A}_{i}} + \frac{1}{{A}_{e}} \qquad ( 2 )$$

The value for Aᵢ can now be obtained in terms of the measured quantities, A_{Li} and Aₑ.

$${A}_{i} = \frac{{A}_{Li} {A}_{e}}{{A}_{e} - {A}_{Li}} \qquad ( 3 )$$

And the transference number is given by

$${t}_{i} = \frac{{A}_{e}}{{A}_{i} + {A}_{e}} \qquad ( 4 )$$

The ASR values were obtained DC measurements of the I-V curves as described below.

Cells were prepared by cutting rectangular pieces from the gage section of the dog-bones. The surface area of the sample (the width was the same as the width of the gage section) and its thickness were measured with a caliper. Cells consisting of Cu|LCO-composite|Cu or Li|LCO-composite|Li architecture were pressed between stainless steel disks and assembled within a Swagelok device with sliding pistons, within the glove box with <0.25 ppm oxygen. The Swagelok was placed between a die set to apply a pressure of 4.5 to 6.3 kPa, to ensure good contact between the electrodes and the ceramic. All measurements were conducted in this configuration in ambient air.

The DC measurements were made with a battery cell tester (Arbin Instruments, Model BT2000, Serial 164005). The electrode to electrode resistance of the cells was measured from the slope of the current vs voltage plots. An example for 10 vol % Ag is shown in FIG. 3. The ASR values were calculated by multiplying the resistance in Ohms by the area of the electrodes in cm2. The results from the three types of composites are summarized in Table III.

TABLE III
ASR values for ionic and electronic transport across
the metal-ceramic composite.

| | Aₑ | A_{Li} | | | | Thick- |
|---|---|---|---|---|---|---|
| Composition | (Cu/Cu) | (Li/Li) | Aᵢ | tᵢ | Area | ness |
| Vol % | Ωcm² | Ωcm² | Ωcm² | Ωcm² | cm² | cm |
| Pure LCO | 103000 | 33756 | 50212 | 0.67 | 0.281 | 0.103 |
| Pure LCO | 44444 | 763 | 776 | 0.98 | 0.242 | 0.080 |
| Ag 5% | 31613 | 7967 | 10651 | 0.75 | 0.291 | 0.098 |
| Ag 5% | 66000 | 20204 | 29117 | 0.69 | 0.288 | 0.099 |
| Ag 10% | 50000 | 10843 | 13846 | 0.78 | 0.329 | 0.090 |
| Ag 10% | 55000 | 18723 | 28386 | 0.66 | 0.290 | 0.088 |
| Ag 15% | 39.59 | 7.00 | 8.50 | 0.82 | 0.298 | 0.094 |
| Ag 15% | 3.58 | 2.00 | 4.53 | 0.44 | 0.147 | 0.095 |
| Al 5% | 11461 | 4096 | 6374 | 0.64 | 0.150 | 0.102 |
| Al 10% | 151429 | 1532 | 1548 | 0.99 | 0.302 | 0.106 |
| Ni 5% | 56000 | 13827 | 18360 | 0.75 | 0.243 | 0.112 |
| Ni 5% | 545000 | 4698 | 4739 | 0.99 | 0.324 | 0.109 |
| Ni 10% | 267500 | 97273 | 152858 | 0.64 | 0.264 | 0.107 |
| Ni 10% | 131250 | 14189 | 15909 | 0.89 | 0.305 | 0.105 |
| Ni 15% | 2705 | 754 | 1045 | 0.72 | 0.343 | 0.089 |
| Ni 15% | 1504 | 374 | 498 | 0.75 | 0.374 | 0.091 |

The scatter in the results for ASR values may result from the variability in the contact resistance between the electrodes and the ceramic. The variability is more pronounced when the metal content is less than 5 vol %. In low volume fractions, a continuous metal path through the composite would have been unlikely and the contact resistance would have been determined by the contact between the ceramic particles and the metal electrodes. The metal-ceramic interface ASR can vary by nearly two orders of magnitude, as has been discovered in earlier work with Li|LLZO|Li cells; the large difference between the ASR values for just LCO, shown at the top of Table III, may be an example of this variability.

The results for 15 vol % Ni and 15 vol % Ag are fairly consistent. The higher electronic conductivity corresponds to a high metal fraction in the metal-ceramic compound. The high value of ionic conductivities in such samples is an unexpected result. There does seem to be a phenomenological correlation between the solubility of lithium in silver and high ionic conductivity. The high ionic conductivities in aluminum, even at low volume fractions of the metal, and even though the electronic conductivities are quite low, is also surprising. Again, lithium is known to have high solid solution solubility in aluminum. The diffusivity of lithium in aluminum is also likely to be higher than in silver because of its lower melting point. However, it is unexpected that the solid solubility of lithium metal atoms in another metal should enhance the ionic transport of lithium ions.

Lithium metal atoms can certainly diffuse through a host of metals, but with lithium metal on either side of the cell, without an applied potential difference, there is no driving force for the transport of Li across the metal ceramic composite. For the Li transport to be related to the current flowing through the circuit (which is then measured as ASR), the diffusion of lithium should be driven by an electrochemical driving force. Therefore, lithium should have the following reaction at the interface, such that the ions are transported through the metal ceramic composite and the electrons via the external electrical circuit.

L→L⁺+e (5)

It is thought that an electric field applied via lithium metal electrodes across a metal, such as silver or aluminum, can provide an electrical driving force for the transport of lithium from one electrode to the electrode on the other side. In order for lithium ions to experience the electrical field within the metal, the ions may form an electrical dipole with the negative electron charge surrounding the ion.

A second explanation for the enhancement of the ionic conductivity of Li+ in the metal ceramic composites is that the ions are transported along the metal-ceramic interfaces, which will have mixed electronic and ionic character.

As set forth above, flash sintering of metal-ceramic compounds/composites made with lithium cobalt oxide and silver, aluminum or nickel, are successful in producing materials with mixed electronic and ionic conductivities suitable for cathode applications in lithium ion batteries. The metal-ceramic compounds/composites show the classical flash behavior where the conductivity rises abruptly when an electric field is applied to specimens held at a constant temperature within a conventional furnace/reaction chamber.

Remarkable increases in the electronic and ionic conductivities is seen when the volume fraction of the metal is 10-15 vol %. The increase is highest for the addition of silver followed by aluminum. While the increase in electronic conductivity had been expected by the metal being able to provide a continuous path through the composite, the increase in the ionic conductivity is unusual.

Flash processing of metal-ceramic composites holds potential for the synthesis of new materials for cathodes with mixed ionic and electronic conductivities in lithium ion batteries. The flash process can be expected to enhance the performance of two phase interfaces in solid state lithium ion batteries.

Although exemplary embodiments of the present disclosure are set forth herein, it should be appreciated that the disclosure is not so limited. For example, although exemplary sintered compounds are described in connection with various specific starting compounds, the disclosure is not necessarily limited to these examples. Various modifications, variations, and enhancements of the methods set forth herein may be made without departing from the spirit and scope of the present disclosure.

The subject matter of the present disclosure includes all novel and nonobvious combinations and subcombinations of the various systems, components, and configurations, and other features, functions, acts, and/or properties disclosed herein, as well as any and all equivalents thereof.

We claim:

1. A method of forming a metal-ceramic composite electrode, the method comprising the steps of:
providing mixture comprising one or more materials and a metal; and
flash sintering the mixture to form a metal-ceramic compound.

2. The method of forming a metal-ceramic composite electrode of claim 1, wherein the metal exhibits solubility for lithium.

3. The method of forming a metal-ceramic composite electrode of claim 1, wherein the one or more materials comprise lithium.

4. The method of forming a metal-ceramic composite electrode of claim 1, wherein the one or more materials comprise cobalt.

5. The method of forming a metal-ceramic composite electrode of claim 1, wherein the one or more materials comprise lithium and cobalt.

6. The method of forming a metal-ceramic composite electrode of claim 1, wherein the metal comprises aluminum.

7. The method of forming a metal-ceramic composite electrode of claim 1, wherein the metal comprises silver.

8. The method of forming a metal-ceramic composite electrode of claim 1, wherein a temperature during the step of flash sintering is between about 300° C. and about 1200 CC.

9. The method of forming a metal-ceramic composite electrode of claim 1, wherein a temperature within a reaction chamber is ramped up at a rate between about 1° C./minute to about 100° C./minute to a temperature of about 300° C. to about 1200° C.

10. The method of forming a metal-ceramic composite electrode of claim 1, wherein an amount of metal in the mixture ranges from about 5 volume percent to about 15 volume percent.

11. The method of forming a metal-ceramic composite electrode of claim 1, further comprising a step of heating the mixture to a first temperature before the step of flash sintering at a second temperature, wherein the first temperature is higher than the second temperature.

12. The method of forming a metal-ceramic composite electrode of claim 1, further comprising the step of forming an electrode using the metal-ceramic compound.

13. The method of forming a metal-ceramic composite electrode of claim 12, further comprising forming a battery using the electrode.

14. The method of forming a metal-ceramic composite electrode of claim 12, further comprising forming a fuel cell using the electrode.

15. A sintered metal-ceramic compound formed according to the method of claim 1.

16. The sintered metal-ceramic compound of claim 15, wherein the sintered metal-ceramic compound forms at least part of an electrochemical cell cathode.

17. The sintered metal-ceramic compound of claim 15, wherein the sintered metal-ceramic compound forms at least part of a fuel cell anode.

18. A method of forming an electrode, the method comprising the steps of:
providing mixture comprising one or more materials and a metal; and
flash sintering the mixture to form a metal-ceramic compound.

19. The method of forming an electrode of claim 18, wherein the one more materials comprise one or more of lithium oxide, cobalt oxide, and lithium cobalt oxide.

20. The method of forming an electrode of claim 18, wherein the metal comprises one or more of silver and aluminum.
